(19) United States
(12) Patent Application Publication
(10) Pub. No.: US 2026/0348214 A1
(43) Pub. Date: Nov. 5, 2026

(54) SLIDING DOOR MECHANISM FOR PIVOTING SLIDING DOOR

(71) Applicants: Andrew Jung, San Marcos, CA (US); Spencer Schaffer, Bakersfield, CA (US); Ngoan Nguyen, Pittsburg, CA (US)

(72) Inventors: Andrew Jung, San Marcos, CA (US); Spencer Schaffer, Bakersfield, CA (US); Ngoan Nguyen, Pittsburg, CA (US)

(21) Appl. No.: 19/195,689

(22) Filed: Apr. 30, 2025

(51) Int. Cl. E05D 15/06; E05D 15/58; E06B 3/40; E06B 3/50

(52) U.S. Cl. CPC E05D 15/0673; E05D 15/0639; E06B 3/5072; E05D 2015/586; E05Y 2201/628; E05Y 2600/314; E05Y 2600/626; E05Y 2800/356; E05Y 2800/372; E05Y 2900/531; E06B 2003/406

(57) ABSTRACT

Top and bottom sliding door mechanisms each include wheels for engagement with guide rails mounting in the top and bottom of a door opening enclosure. In each mechanism a support block is pivotably mounted to the wheels and one side of a connector plate is attached to the top or to the bottom of a door opening frame and the other side is connected to the support block by one or more bolts. The door frame is thus pivotable with respect to the door opening enclosure. The distance between the connector frame and the support block in each of the top and bottom mechanisms can be adjusted by tightening or loosening the bolts which in turn adjusts the distance between the wheels relative to the distance between the guide rails to minimize binding and play of the pivoting door as it slides within the door opening.

### BACKGROUND

### Technical Field

The present invention relates generally to mechanisms that allow pivoting doors mounting in a door opening enclosure to slide within the enclosure such as between open and closed positions. CPC EO5D

### Description of Related Art

Mechanisms that allow doors to pivot and slide in a door enclosure are designed to provide both functionality and aesthetic appeal. Pivot doors operate on a pivot axis, typically mounted at the top and bottom of the door, that allows the door to rotate smoothly around a fixed point, enabling it to open by pivoting perpendicular to the door enclosure. The pivot point can be located anywhere along the door panel but locating it at the center of the door will ensure balanced movement and stability. This design is particularly useful in high-traffic areas, as it provides a wide clearance for people and objects to pass through.

Sliding doors, on the other hand, operate by moving along a track system installed either at the top, bottom, or both. Sliding doors are commonly equipped with rollers or gliders that facilitate smooth horizontal movement. Sliding doors are ideal for spaces where traditional swinging doors might be impractical due to space constraints and are often designed to slide into a wall cavity (e.g., pocket doors) or along the exterior of the wall.

Combining pivot and sliding mechanisms in a single door system can offer enhanced flexibility and space-saving benefits, making them suitable for both residential and commercial applications. It has been found that pivoting doors that slide horizontally along a door opening enclosure tend to exhibit play between top and bottom pivot mechanisms that result in binding and hence difficulty sliding the door smoothly in the enclosure.

### SUMMARY OF THE INVENTION

A sliding pivoting door mechanism solves this problem by providing a way to adjust the distance between the guide wheels of top and bottom pivoting sliding door mechanisms in relation to the distance between top and bottom guide rails mounting in a door opening enclosure. According to the invention, a pivoting sliding door mechanism generally consists of top and bottom units which work together cooperatively. Each pivoting sliding door mechanism has guide wheels that slide along guide rails mounting in the top and bottom of a door opening enclosure and which define a guide rail separation distance. The distance between the top guide wheels and the bottom guide wheels defines a wheel separation distance.

Each pivoting sliding door mechanism comprises an axle, one end of which is connected to the guide wheels. The other end is connected to a bearing which is captured in a bearing support block. The bearing support is thus pivotably connected to the axle. The bearing is connected to a connector block by several bolts; the connector block is attached to the door frame. The door frame is therefore pivotable with respect to the door opening enclosure.

The distance between the support block and the connector block in each of the top and bottom pivoting sliding door mechanisms is adjustable by tightening or loosening the bolts. The distance between the support block and the connector block defines a support block-connector block distance. Adjustment of either or both of the support block-connector block distances of the top and bottom pivoting sliding door mechanisms therefore adjusts the wheel separation distance. The wheel separation distance and thus be adjusted with respect to the guide rail separation distance to minimize binding and play of the pivoting sliding door with and along the door opening mechanism.

### BRIEF DESCRIPTION OF THE DRAWINGS

FIG. 1 is a top perspective view of a door frame mounting in a door opening enclosure using top and bottom pivoting sliding door mechanisms.

FIG. 2 is a top perspective view similar to FIG. 1 showing the door frame pivoted to an open position roughly perpendicular to the door opening enclosure.

FIG. 3 is a top plan view showing the door sliding within the door opening enclosure.

FIG. 4 is a bottom perspective view of a top sliding door mechanism.

FIG. 5 is an elevational view thereof.

FIG. 6 is an exploded view thereof.

FIG. 7 is a bottom perspective view of a bottom sliding door mechanism.

FIG. 8 is an elevational view thereof.

FIG. 9 is an exploded view thereof.

FIG. 10 is a representation of the relationship between the distance between the top and bottom wheels relative to the distance between the top and bottom guide rails as may be adjusted by the top and bottom sliding pivoting mechanisms.

### DETAILED DESCRIPTION OF THE ILLUSTRATED EMBODIMENT

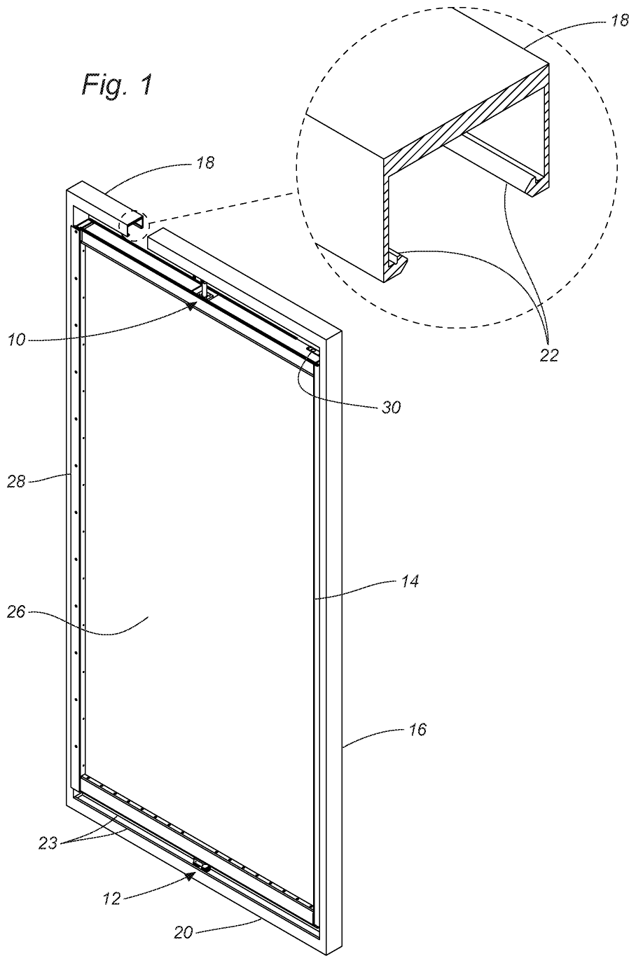

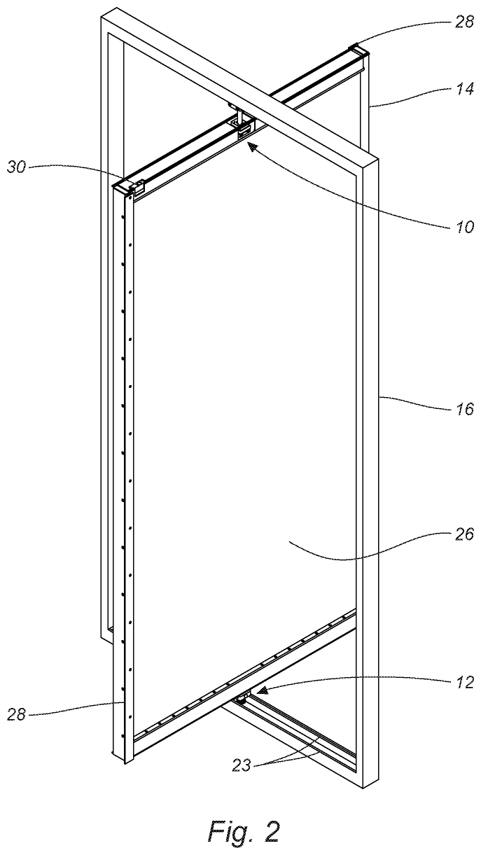

A sliding door mechanism for a pivoting sliding door is now described with respect to the drawing figures. Sliding door mechanisms for pivoting doors generally will be deployed in cooperating pairs, such as top and bottom door mechanisms 10, 12 seen in FIG. 1, that allow a door frame 14 to pivot within a door opening enclosure 16. For example, door frame 14 is shown in a closed position with respect to door opening enclosure 16 in FIG. 1 and in an open position in FIG. 2.

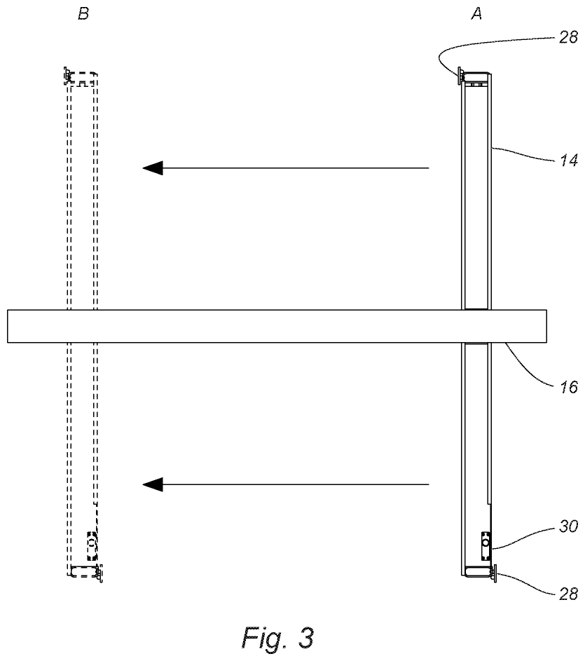

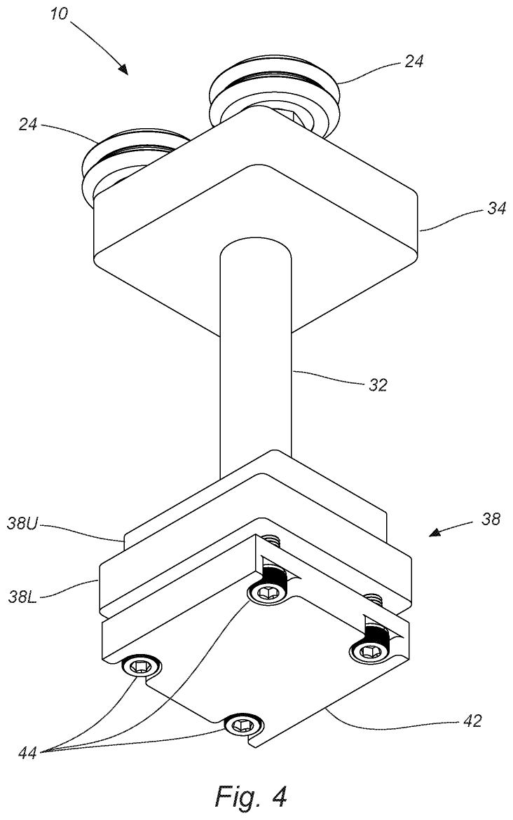

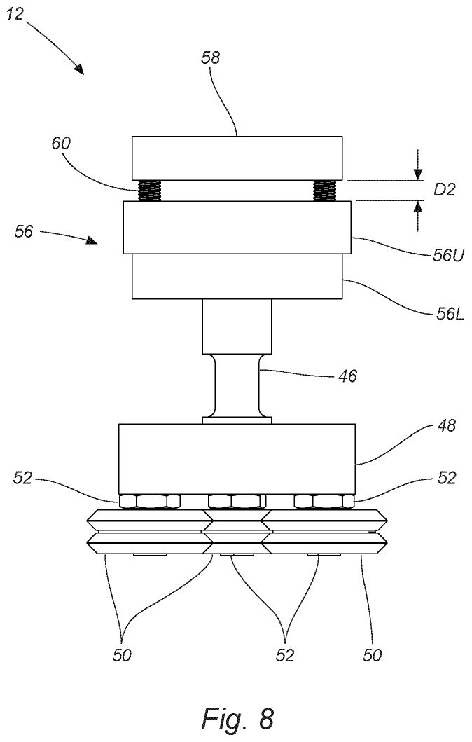

In addition to pivoting within the door opening enclosure 16, the door frame 14 can slide from a first position A within the enclosure to a second position B as seen in FIG. 3. The top 18 and bottom 20 of the door opening enclosure have top and bottom guide rails 22, 23 as shown which engage guide wheels of sliding door mechanisms 10, 12 thereby enabling a door frame to pivot and slide within a door opening enclosure as seen. In one embodiment, the guide rails have a V-shaped profile to best engage dual V-shaped wheels 24, 50 such as those seen in FIGS. 4-9. Suitable dual V-shaped wheels are DualVee® guide wheels available from Bishop-Wisecarver Corporation. Suitable cooperating V-shaped guide track are UtiliTrak® or DualVee® Single Edge Track also available from Bishop-Wisecarver Corporation. In other embodiments, the door frame 14 may encase one or more sheets of glass 26, may have side flanges 28 that overlap the door opening enclosure 16 when the door frame is in the closed position as seen in FIG. 1, and may have a lock-receiving plate 30 for receiving the locking shaft of a lock (neither illustrated) mounted in the door opening enclosure 16. In another embodiment, the lock may be magnetically activated.

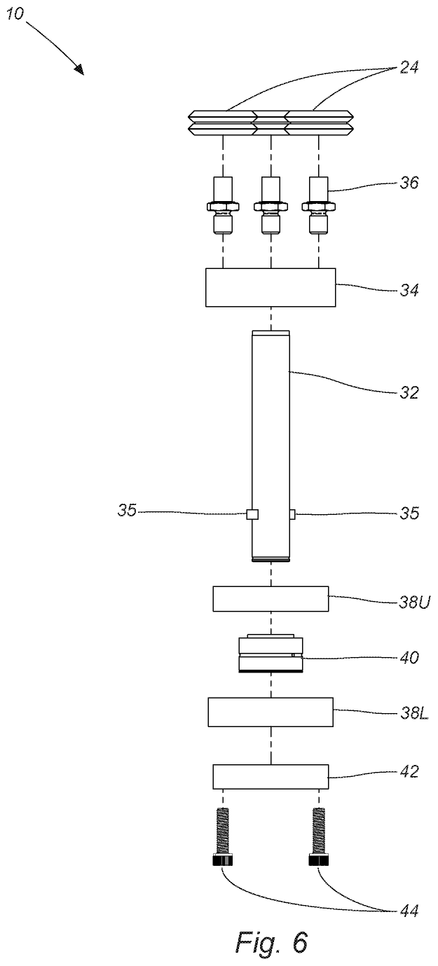

With reference now to FIGS. 4-6, a top pivoting sliding door mechanism 10 includes a top pivot shaft 32, the upper end of which is attached to a top wheel plate 34. In one embodiment, top pivot shaft 32 may be provided with outwardly extending engagement bars 35 (see FIG. 6) which can be used to limit its pivoting movement relative to support block 38 discussed below. Top wheels 24 are rotatably connected to the top wheel plate 34 via top wheel shafts 36 for rolling engagement with top guide rails 22 as mentioned above. Top bearing support block 38 comprises upper bearing block 38U which in turn is affixed to lower bearing block 38L. Upper and lower support blocks 38U, 38L cooperate to capture bearing 40 (see FIG. 6). The lower end of pivot shaft 32 is engaged with bearing 40 to pivotably connect the pivot shaft 32 with support block 38.

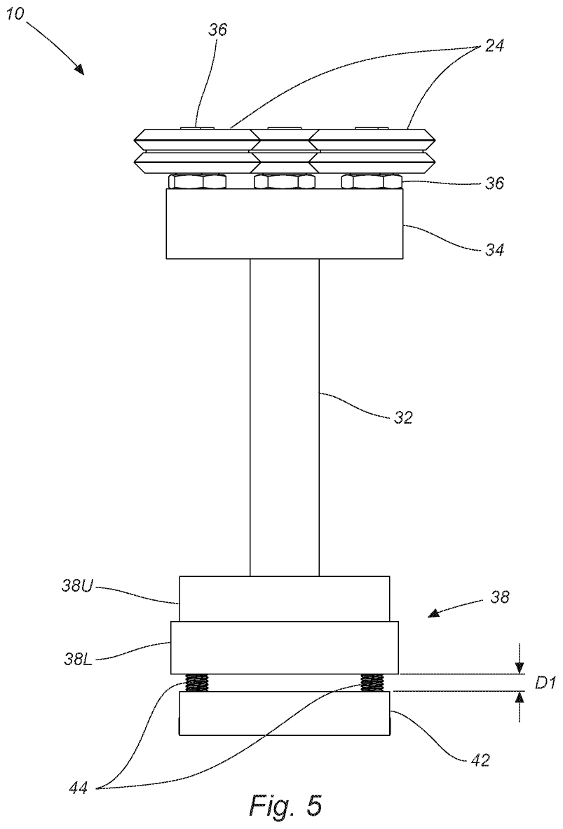

Top bearing support block 38 is adjustably attached to top connector plate 42 by top bolts 44. In the illustrated embodiment, top bearing support block 38 is attached to top connector plate 42 by four bolts, but in other embodiments one to three or more than four bolts could be used. As can be understood from the illustrations, tightening top bolts 44 closes and loosening bolts 44 widens the distance between the top bearing support block 38 and the top connector plate 42 which defines a top connector plate top support block distance D1 as best seen in FIG. 5.

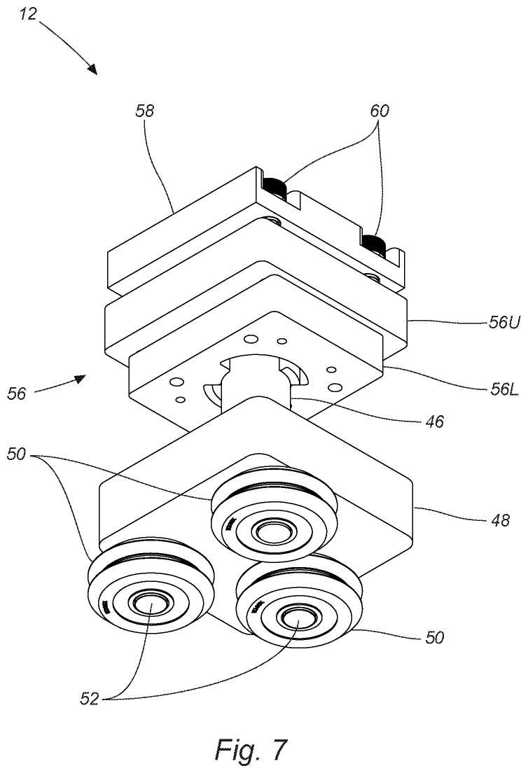

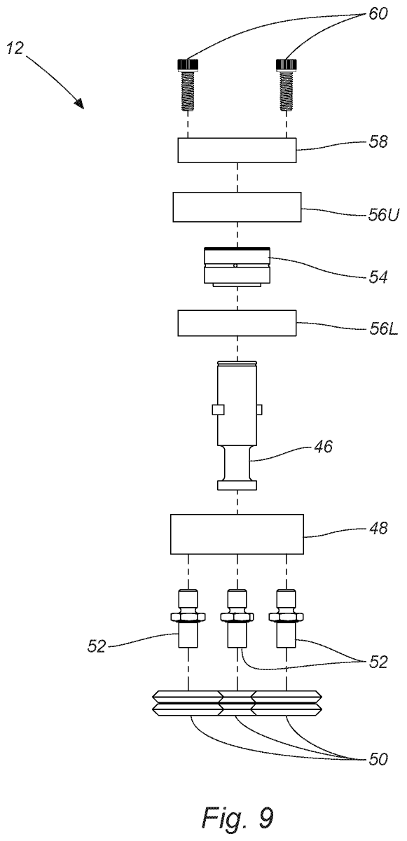

With reference now to FIGS. 7-9, a bottom pivoting sliding door mechanism 12 includes a bottom pivot shaft 46, the lower end of which is connected to a bottom wheel plate 48. Bottom wheels 50 are rotatably connected to the bottom wheel plate 48 via bottom wheel shafts 52 for rolling engagement with the bottom guide rails 23 as discussed above. The upper end of the bottom pivot shaft 46 is engaged with bottom bearing 54 (see FIG. 9) which is captured between upper bearing block 56U and lower bearing block 56L which are cooperatively affixed to each other to form bottom bearing support block 54. The bottom pivot shaft 46 is thereby pivotably connected with bottom bearing support block 54.

Similarly to the top pivoting sliding door mechanism 10 discussed above, the bottom bearing support block 54 is adjustably attached to bottom connector plate 58 by four bottom bolts 60 in the illustrated embodiment. However, in other embodiments one to three or more than four bolts could be used. Tightening bolts 60 closes and loosening bolts 60 widens the distance between the bottom bearing support block 54 and the bottom connector plate 58 which defines a bottom connector plate-bottom support block distance D2.

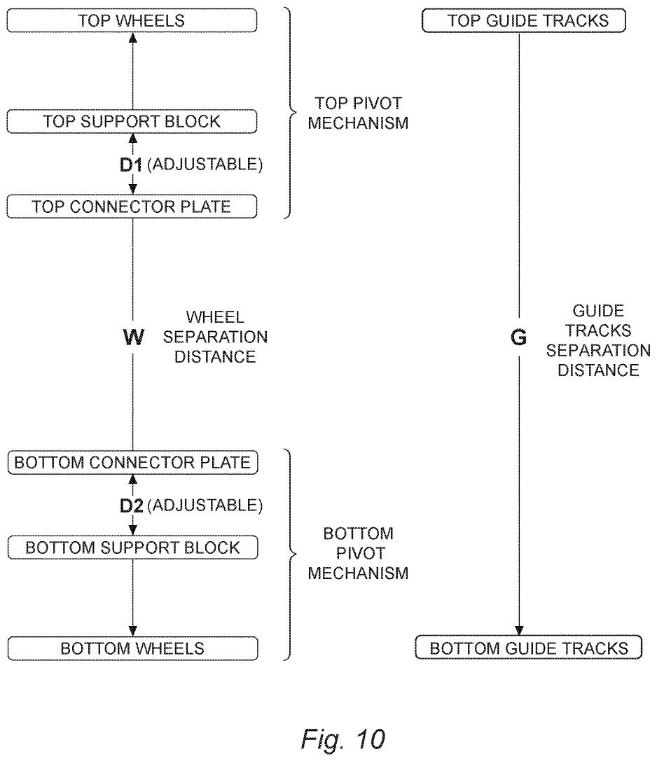

With reference now to FIG. 10, it is seen that by adjusting the top connector plate-top support block distance D1 or the bottom connector plate-bottom support block distance D2, or both, the distance W between the top and bottom wheels can be adjusted relative to the distance G between the top and bottom guide rails to minimize play and binding as the door frame 14 is pivoted and slid in the door opening enclosure 16. It will be understood that the technology also allows the height of the pivoting sliding door within a door opening enclosure to be adjusted as needed. Applicants have found that employing pivoting sliding door mechanisms will enable even very heavy doors to pivot and slide easily in a door opening enclosure providing a new and distinct advantage over the prior art.

There have thus been described and illustrated certain embodiments of a sliding door mechanism for a pivoting sliding door according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

1. A sliding door mechanism for pivoting sliding doors, the sliding door mechanism comprising:
a door opening enclosure having one or more top guide tracks and one or more bottom guide tracks, the one or more top guide tracks spaced from the one or more bottom guide tracks by a guide tracks separation distance,
a door frame having top and bottom rails,
two or more top wheels configured for engaging said one or more top guide tracks,
two or more bottom wheels pivotably affixed to the bottom rail of the door frame, said two or more bottom wheels also configured for engaging said one or more bottom guide tracks,
said two or more top wheels spaced from said two or more bottom wheels by a wheel separation distance, and
one or more support blocks and one or more connector plates, one of the one or more support blocks affixed to one of said two or more top wheels or said two or more bottom wheels, one of the one or more connector plates affixed to one of said top or bottom rails, said connector plate adjustably affixed to said support block so that said connector plate and said support block are adjustably spaced apart by a connector plate-support block distance,
such that by adjusting the connector plate-support block distance the wheel separation distance can be adjusted relative to the guide tracks separation distance to minimize binding and play as the door frame slides along the top and bottom guide tracks within the door opening enclosure.

2. The sliding door mechanism of claim 1 further comprising:
said connector plate affixed to said support block by one or more threaded fasteners, and rotation of said one or more threaded fasteners increases or decreases said connector plate-support block distance.

3. The sliding door mechanism of claim 1 further comprising:
said two or more top wheels pivotably connected to said top rail, and
said two or more bottom wheels pivotably connected to said bottom rail,
so that the door frame can pivot with respect to the door opening enclosure.

4. The sliding door mechanism of claim 3 further comprising:
A sliding door mechanism for pivoting sliding doors, the sliding door mechanism comprising:
a door opening enclosure having one or more top guide tracks and one or more bottom guide tracks, the one or more top guide tracks spaced from the one or more bottom guide tracks by a guide tracks separation distance,
a door frame having a top rail and a bottom rail.
two or more top wheels and a top pivot shaft, said two or more top wheels configured for engaging said one or more top guide tracks, said top pivot shaft connected to said two or more top wheels,
said two or more top wheels spaced from said two or more bottom wheels by a wheel separation distance,
said two or more bottom wheels pivotably connected to the bottom rail of said door frame so that the door frame can pivot with respect to the door opening enclosure, and
one or more support blocks and one or more connector plates, said one or more support blocks including a top bearing support, said top pivot shaft rotatably captured in said top bearing support,
one of the one or more connector plates affixed to one of said top or bottom rails, so that one of said two or more top wheels or said two or more bottom wheels is pivotably connected to the top rail or the bottom rail of said door frame,
said connector plate adjustably affixed to one of said support blocks so that said connector plate and said support block are adjustably spaced apart by a connector plate-support block distance,
such that, by adjusting the connector plate-support block distance, the wheel separation distance can be adjusted relative to the guide tracks separation distance to minimize binding and play between said top and bottom wheels and said top and bottom guide tracks as the door frame slides within the door opening enclosure.

5. The sliding door mechanism of claim 4 further comprising:
a bottom pivot shaft connected to said one or more bottom wheels,
the one or more support blocks including a bottom support block connected to said bottom rail, said bottom support block including a bottom bearing support, the bottom pivot shaft rotatably captured in the bottom bearing support.

6. The sliding door mechanism of claim 1 further comprising:
the one or more bottom guide tracks comprising V-track bottom rails guide tracks,
said two or more bottom wheels configured to work cooperatively with said V-track bottom guide tracks.

7. The sliding door mechanism of claim 1 further comprising:
the one or more top guide tracks comprising V-track top guide tracks,
said two or more top wheels configured to work cooperatively with said V-track top guide tracks.

8. A sliding door mechanism for pivoting sliding doors, the sliding door mechanism comprising:
a door opening enclosure having one or more top guide tracks and one or more bottom guide tracks, the one or more top guide tracks spaced from the one or more bottom guide tracks by a guide tracks separation distance,
a door frame having a top rail and a bottom rail,
a top pivot mechanism affixed to said top rail, the top pivot mechanism having two or more top wheels configured for engaging said one or more top guide tracks,
a bottom pivot mechanism affixed to said bottom rail, the bottom pivot mechanism having two or more bottom wheels configured for engaging said one or more bottom guide tracks,
said two or more top wheels spaced from said two or more bottom wheels by a wheel separation distance,
one or more support blocks and one or more connector plates, one of the one or more support blocks affixed to one of said two or more top wheels or said two or more bottom wheels, one of the one or more connector plates affixed to one of said top or bottom rails, said connector plate affixed to one of said support blocks by one or more threaded fasteners, said connector plate and said support block are spaced apart by a connector plate-support block distance, rotation of said one or more threaded fasteners increasing or decreasing said connector plate-support block distance,
such that by rotating said threaded fasteners to adjust the connector plate-support block distance the wheel separation distance can be adjusted relative to the guide tracks separation distance to minimize binding and play as the door frame slides along the top and bottom guide tracks within the door opening enclosure.

9. A sliding door mechanism for pivoting sliding doors, the sliding door mechanism comprising:
a door opening enclosure having one or more top guide tracks and one or more bottom guide tracks, the one or more top guide tracks spaced from the one or more bottom guide tracks by a guide track separation distance,
a door frame having a top rail and a bottom rail,
two or more top wheels configured for engaging said one or more top guide tracks,
two or more bottom wheels configured for engaging said one or more bottom guide tracks, said bottom wheels pivotably connected to said bottom rail,
said two or more top wheels spaced from said two or more bottom wheels by a wheel separation distance,
a top support block, a top connector plate, and a top pivot shaft, said top support block including a top bearing support block, the top pivot shaft captured in said top bearing support, said top pivot shaft connected to said two or more top wheels, said top connector plate affixed to said top rail,
said top connector plate affixed to said top support block by one or more threaded fasteners, said top connector plate and said top support block spaced apart by a top connector plate-top support block distance, rotation of said one or more threaded fasteners increasing or decreasing said top connector plate-top support block distance, and
a bottom support block, a bottom connector plate, and a bottom pivot shaft, said bottom support block including a bottom bearing support block, the bottom pivot shaft captured in said bottom bearing support, said bottom pivot shaft connected to said two or more bottom wheels, said bottom connector plate affixed to said bottom rail,
said bottom connector plate affixed to said bottom support block by one or more threaded fasteners, said bottom connector plate and said bottom support block spaced apart by a bottom connector plate-bottom support block distance, rotation of said one or more threaded fasteners increasing or decreasing said bottom connector plate-bottom support block distance,
such that, by rotating said threaded fasteners to adjust the top connector plate-top support block distance and the bottom connector plate-bottom support block distance, the wheel separation distance can be adjusted relative to the guide rail separation distance to minimize binding and play as the door frame slides along the top and bottom guide tracks within the door opening enclosure.

10. The sliding door mechanism of claim 9 further comprising:
the one or more top guide tracks comprising V-track guide tracks,
said two or more top wheels configured to work cooperatively with said V-track, and
the one or more bottom guide tracks comprising V-track guide tracks,
said two or more bottom wheels configured to work cooperatively with said V-track guide tracks.

11. The sliding door mechanism of claim 1 wherein said one or more top guide tracks, said one or more bottom guide tracks, said two or more top wheels, and said two or more bottom wheels are all horizontally disposed to that said guide tracks horizontally abut said wheels.
